(19) United States
(12) Patent Application Publication
(10) Pub. No.: US 2014/0038130 A1
(43) Pub. Date: Feb. 6, 2014

(54) System for Maintaining Tooth Contact During Interproximal Dental Restoration

(71) Applicant: Ming H. J. Pun, Powell, OH (US)

(72) Inventor: Ming H. J. Pun, Powell, OH (US)

(21) Appl. No.: 13/562,911

(22) Filed: Jul. 31, 2012

(51) Int. Cl. A61C 5/12; A61C 5/04

(52) U.S. Cl. 433/139; 433/226; 433/136

(57) ABSTRACT

The disclosure provides for an improved system for utilizing matrix bands in dental restorations. The system allows for maintaining or recreating close interproximal contacts between teeth following restoration. A matrix band is provided which retains in place a contact matrix that upon completion of the restoration is tightly bound to the filling matrix deposited into the cavity, and thus maintains or recreates a tight contact with adjacent teeth. The system provides an improved system for use in dental surgery, and by implementing the kit provided clinicians are able to provide enhanced results following restoration with a minimum of effort.

### CROSS-REFERENCE TO RELATED APPLICATIONS

Not applicable.

### STATEMENT REGARDING FEDERALLY SPONSORED RESEARCH

Not applicable.

### BACKGROUND

1. Field of the Invention

The present disclosure generally relates to dental appliances and methods involved in dental restorations. In particular it relates to matrix bands used during the filling of tooth cavities. The disclosure demonstrates a new system for ensuring tight proximal contacts between teeth after the dental matrix band has been removed following a dental restoration.

2. Description of the Related Art

One of the most common practices of dentists is the treatment of dental cavities, or caries that grow in teeth. The mammalian tooth is a structure comprising an enameled crown supported by one or more roots embedded in the mandible or maxilla, bones of the upper and lower jaw. The enamel is the highly mineralized hard tissue on the outside of the tooth. The calcium phosphate rich enamel is secreted, supported and nourished by the hard tissue, dentin, of the tooth body, with a soft pulp core, supplied by blood. A layer of cementum and the periodontal membrane anchor the tooth in the underlying bone structure of the jaw, in conjunction with the gums, or gingiva Enamel, when healthy, is one of the hardest natural substances, but is susceptible to decay and the formation of cavities.

Cavities are holes in teeth caused by the acids present in dental plaque. Bacteria in the mouth produce acids when in the presence of sugars such as sucrose, fructose and glucose. Food debris remaining in the teeth of an individual can cause the production of these acids. The acids demineralize the tooth's hard tissues: enamel, dentin and cementum. Lactic acid produced by oral bacteria when they consume sugars. The acid causes demineralization of crystals in the enamel, which can allow the acids to penetrate deeper into the tooth, causing cavities. Cavities, if left untreated, can penetrate the enamel and affect the cementum, the calcified substance covering the root of the tooth, and the dentin, the calcified body that makes up the majority of the tooth's structure, of the tooth.

Dentists can treat cavities by removing decayed tissue. Dentist then insert a dental restoration, or filling, into the prepared cavity in the tooth. Fillings can be made of several different materials including silver alloy, gold, porcelain, or composite resin. When performing a dental restoration, a dentist generally numbs the area around the tooth to be restored with a local anesthetic. He or she then uses an instrument, often a high-speed dental drill to remove the decayed portion of the tooth. After the decay is removed, the dentist shapes the targeted area using burs to prepare the area receiving the restoration to receive the filling. The dentist may place a base or liner in the space to protect the pulp of the tooth. The dentist then places the unhardened restoration into the area of the tooth that has been prepared. After the filling is placed, the dentist will shape the filled area using burs to restore the tooth's proper anatomic contours. The process of hardening and shaping the tooth and restoration after the restoration has been placed in the prepared area varies based on the type of filling that is used in the procedure, established practice, and the preference of the dentist.

The particular dental restoration procedure used is dependent on the affected tooth, where on the tooth the cavity has developed, and where the restoration is to be placed. For cavities that have developed on the occlusal, or biting, surfaces of teeth in the rear of the patient's mouth, the restorative material may be able to be held in place by the remaining material of the teeth. When cavities have developed along the sides or edges of a tooth, however, there may not be sufficient dental material remaining to hold the restorative material in place until it has hardened sufficiently. A particular type of restoration, a type II interproximal cavity preparation involves a cavity between the adjacent surfaces of two teeth.

In such a situation dentists often employ a matrix band to serve as a barrier to hold the restorative material in its proper place on the tooth until the material has sufficiently hardened. The bands are made to mimic the proximal contours of the patient's tooth so that, once the procedure is completed, the patient's tooth with the restorative material added will be as close to natural as possible. Matrix bands are very thin flexible pieces of metal, often made of stainless steel, but can also be made of brass or copper. Typical thickness of the band body is 30 to 50 micrometers. Certain types of matrix bands are made of plastic or similar flexible materials with high tensile strength. The main function of the matrix is to restore proper anatomic proximal contours and contact areas to the tooth or teeth involved in the dental restoration procedure and their adjacent teeth.

The bands are very thin because they are placed between the tooth receiving the restoration and an adjacent tooth. The occlusal edge of the band is placed towards the occlusal surface of the tooth, while the gingival edge is placed towards the gingiva, or gums. Bands are available for use with specific teeth (premolar or molar), and universal bands are also available. Before inserting the matrix band in between the tooth structure of the damaged tooth and the adjacent tooth the matrix band must be shaped, or burnished, to give the band a contour that is properly adapted to the structure of the tooth. A dentist may burnish the band by rubbing a blunt dental instrument along the length of the band to introduce a curvature to the matrix band.

Dental wedges are usually used along with matrix bands in dental restoration procedures. Wedges have traditionally been wooden but are also available in a variety of plastic materials. Specialized wedges are available that are suited to particular areas of the mouth, or a dentist can personally contour a wedge so that it properly fits the mouth of the patient. The dentist places the dental wedge along the gingiva between the tooth to be restored and the adjacent tooth. A proper-fitting wedge should cover the entire gingival proximal surface between the teeth. Wedges are used to slightly separate the adjacent teeth to compensate for the thickness of the matrix band, helping to create a tight contact between the finished restoration and the adjacent tooth. If a wedge is not used with the band, a space equal to the thickness of the band can remain between the proximal surface of the teeth receiving the restoration and the adjacent tooth when the band is removed following the procedure. The dental wedge also compresses the matrix band against the tooth to create a tighter seal. Wedges also prevent gingival overhang.

While the matrix band is the operative element in a dental restoration procedure, the band must be held in place by a matrix retainer. Two types of matrix band systems are commonly used by dentists. The Universal matrix system uses a device with a U-shaped head with three slots into which the band is positioned. A locking vise with a sliding body is used to hold the band. A knob at the middle of the device can be turned to change the diameter of the loop in the band based on the size of the tooth. A knob on the outside of the device locks the band in place, and can also be used to tighten the spindle. A matrix band is placed into the guides of the device and is then placed around the circumference of the tooth receiving the restoration. The knob at the middle of the device is turned to properly position the band around the tooth. The outer knob can be used to tighten the band to the sides of the tooth to create a tight contact with the tooth. The Universal system is also referred to as a Tofflemire matrix system. U.S. Pat. No. 3,517,444 to Tofflemire discloses an example of such as system.

The other common matrix band system is a sectional matrix band system. The sectional system consists of a contoured matrix band, or shim, and a “BiTine” ring. The shim is a smaller piece of metal than used in the Tofflemire system, and the BiTine Ring is an open ring with legs extending downwards from the curvature towards the gums of the patient. The BiTine ring is applied interproximally between the tooth to be restored and the adjacent tooth. The BiTine ring applies a wedging force that enhances contact formation and aids in the proximal contouring of the dental restoration. The BiTine ring is applied by first using dental pliers to separate the legs of the ring, which are then positioned to straddle the interproximal area adjacent to the dental wedge and the matrix band. The force of the legs creates a slight separation between the decayed tooth and the adjacent tooth. U.S. Pat. No. 5,788,487 to Meyer and U.S. Pat. App. No. 2002/0155410 to Bills provide examples of the elements of the sectional matrix band system. BiTine rings and related matrix bands and accessories are available under the Palodent brand of Dentsply Caulk of Milford, Del.

Though the two above matrix band systems are the most popular systems currently employed by dentists, the systems have shown several shortcomings in their ability to create tight proximal contacts between the tooth receiving the dental restoration and the adjacent tooth following the procedure. Because the matrix band must remain in place during the dental restoration procedure and until the restoration has hardened the proximal contact between the restored tooth and the adjacent tooth can be compromised. The width of the matrix band, though slight, is still enough to result in dental problems associated with loose proximal contacts or physical gaps between teeth.

Research has suggested that the lack of a tight proximal contact can cause several dental problems for the patient. Loose proximal contacts can be a factor in food impaction and retention. Impaction and retention of food between teeth can result in further damage to the tooth and its enamel. Loose proximal contacts can also lead to dental migration, periodontal complications and carious lesions.

To alleviate such problems created by current matrix band systems, there is an unmet need for a matrix band system that provides for the function of the band, but which also provides for the maintenance of tight proximal contact during the dental restoration procedure, more thoroughly replaces or restores the proximal contacts after the procedure is completed, or that provides a replacement for the natural proximal contact to help avoid issues resulting from loose proximal contacts. The present disclosure is directed to providing such a system that minimizes the interproximal tooth gap, and improves the dental quality of interproximal tooth restorations.

### BRIEF SUMMARY

The disclosure includes embodiments of an apparatus, namely a dental restoration contact matrix band comprising: an elongated strap formed of impervious material with high tensile strength, said strap having a first and a second opposing ends, a body adapted to wrap around a tooth to be restored, said body having continuous upper and lower edges which extend between said first and second opposing ends, and an aperture retaining a contact matrix

A further embodiment is a method for repairing an inter-proximal cavity during restoration of a tooth comprising: (a) inserting a contact matrix band in the interproximal gap adjacent to the inter-proximal cavity, said contact matrix band having a contact matrix approximating the form of the preexisting inter-proximal contact, said contact matrix compatible with the filling matrix and removeable from the contact matrix band; (b) clamping the contact matrix band to close apposition with the borders of the inter-proximal cavity and desired inter-proximal contact; (c) placing filling matrix in the cavity of the tooth in close contact with the walls of the cavity and the mesial surface of the contact matrix; (d) allowing the filling matrix to cure and to bond with the contact matrix; and (e) displacing the contact matrix band from the inter-proximal gap without displacing the contact matrix, wherein the contact matrix is permanently bound to the filling matrix and provides a close contact with the adjacent tooth, while minimizing the inter-proximal gap. The method disclosed provides a matrix band compatible with a Tofflemire clamp, a Bitine clamp, or a ring clamp.

In a further embodiment, a contact matrix band is provided with a channel, a perforation strip, or a perforation strip and a channel. Said matrix bands can be provided as a collection of matrix bands with 3 or more shapes of contact matrices.

Another embodiment of the apparatus and system is a dental restoration contact matrix band comprising a) an elongated band portion formed of impervious material with high tensile strength, said band portion having a first and a second opposing ends, and a body with a cross section thin enough to be inserted into the interproximal gap between two teeth; b) a contact matrix formed of contact matrix material with a contact matrix area approximating the form of the preexisting inter-proximal contact; c) said contact matrix material being sufficiently compatible with an expected filling matrix to form a permanent bond between the contact matrix material and the filling matrix; d) an association between the band portion and the contact matrix that allows the contact matrix band to be separated from the contact matrix band during a dental restoration procedure; whereby when a dental restoration is performed, the contact matrix band is placed in a position occupying the interproximal gap between the teeth, and filling matrix is used to fill a cavity said filling matrix bonds with a proximal surface of the contact matrix so that the association between the band portion and the contact matrix can be broken, without displacing the contact matrix, allowing the band portion to be removed, and allowing the contact matrix to remain in the interproximal gap between the teeth, so that the contact matrix is permanently bound to the filling matrix and provides a close contact with the adjacent tooth, while minimizing the inter-proximal gap.

The contact matrix band is further embodied in a contact matrix that is a rectangular, square, circular, dumbbell, dog bone, or irregularly shaped area and wherein the width to length ratio of the matrix band body is one or more of approximately 1 to 20, approximately 1 to 10, approximately 1 to 5, approximately 2 to 1, or approximately 1 to 1.

Yet another embodiment is a contact matrix band further comprising the proximal surface of the contact matrix that has been abraded, roughened with a number of irregularly shaped protrusions, formed to have channels, or formed to have irregularly shaped surfaces and cavities wherein the proximal face exhibits enhanced bonding to a filling matrix.

In yet another embodiment, the system and apparatus for use with the claimed method are comprised of a kit providing components necessary for implementing a contact matrix band system comprising a series of contact matrix bands of variable sizes; a selection of several sizes of contact matrix affixed to the contact matrix band said contact matrix being proportional to an interproximal contact area; a selection of several shapes of contact matrices for filling interproximal gaps;

The system shown in the accompanying figures merely illustrates the various components of the contact matrix band system and is not a limitation of the disclosure.

### BRIEF DESCRIPTION OF THE DRAWINGS

For a fuller understanding of the nature and advantages of the present assembly and components thereof, reference should be had to the following detailed description taken in connection with the accompanying drawings, in which:

FIG. 1 is an overhead view of a matrix band that utilizes the various components disclosed herein;

FIG. 2 is an overhead view of a typical bi-tine ring used for restoration;

FIG. 3 is a side view of a contact matrix band;

FIG. 4 is a perspective view of two teeth with a restoration contemplated in the interproximal gap between the teeth;

FIG. 5 is a top view of two teeth with a contact matrix band inserted in the interproximal gap between the teeth during the process of dental restoration;

FIG. 6 is a side view of two teeth with a partial cross section, during dental restoration prior to the placement of filling matrix in the prepared cavity;

FIG. 7 is a side view of two teeth with a partial cross section, during dental restoration after the placement of filling matrix in the prepared cavity;

FIG. 8 is a side view of two teeth with a partial cross section, during dental restoration after removal of the contact matrix band body following restoration of the cavity;

FIG. 9 is a top view of a contact matrix emplaced in the interproximal gap between two teeth, using the embodied system;

FIG. 10A-C are front views of alternative embodiments of the contact matrix band;

FIG. 11A-C are front views of embodiments of the contact matrix band with a contact matrix channel;

FIG. 12 is a top view of a contact matrix band similar to the embodiment shown in FIG. 11A;

FIG. 13 is a side view of a contact matrix band shown as it may be placed on a molar;

FIG. 14 are several views of various contact matrices; and

FIG. 15A-C are top views of contact matrix bands were the contact matrices are embodied for enhanced bonding to filling matrix.

The drawings will be described in further detail below.

### DETAILED DESCRIPTION

The contact matrix band of the presently disclosed embodiments is adaptable for use with a number of matrix band apparatuses that are widely used in dentistry. The contact matrix band solves a continuing problem of the inability to maintain tight interproximal contacts following a Type II dental restoration.

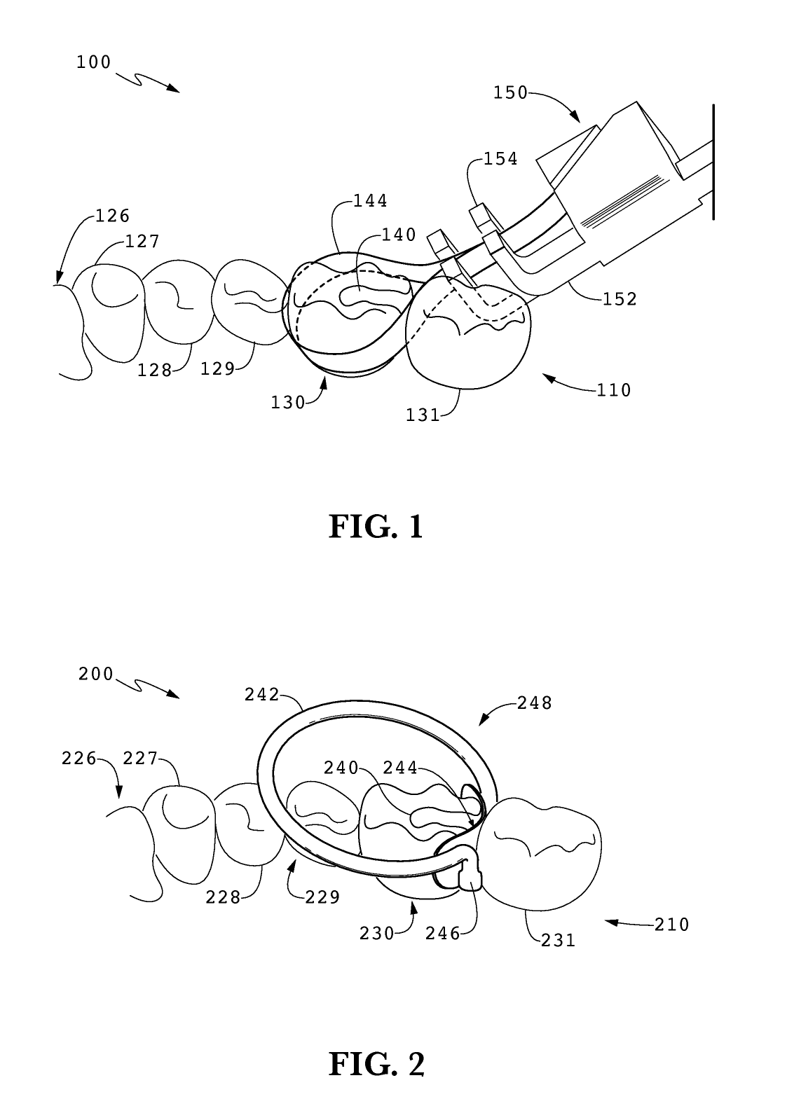

FIG. 1 shows a typical dental restoration 100 utilizing existing matrix band systems on a posterior mandibular tooth, a molar of the lower jaw, at 110. Teeth 126-131 (representing mandibular teeth 26-31) are in close contact with one another. Tooth 130 is in need of restoration, with shaded area 140 representing the location of a dental carie that has been removed to leave a cavity in need of dental restoration. The restoration shown in FIG. 1 illustrates an interproximal Class 2 cavity preparation, known to those skilled in the art of dentistry. The restoration of tooth 130 extends to the proximal border of tooth 130, so that following the removal of tooth material during restoration of tooth 130, the contact between the posterior surface of tooth 130 and the anterior surface of tooth 131 is removed. The proper restoration of tooth 130 relies on the re-establishment of the close contact between the posterior surface of tooth 130 and the anterior surface of tooth 131.

Proper dental restoration procedure utilizes a matrix band, as at matrix band 144, to provide a border for the creation of a restoration filling. Matrix band 144, when properly implemented is preferably in a position where the insertion of a filling fills the space between the cavity 140 and matrix band 144, and following removal of matrix band 144, recreates the close contact between tooth 130 and tooth 131. Existing practices often rely on a Tofflemire clamp 150, with clamp jaws 152 and 254 to tighten matrix band 144 around tooth 130. As described above, the thickness of the matrix band 144 introduces a difficulty in forming a close contact between the posterior surface of tooth 130 and the anterior surface of tooth 131. Following restoration, removal of matrix band 144 leaves a gap approximating the thickness of matrix band 144.

FIG. 2 illustrates an alternative system in current use, replacing the Tofflemire clamp and extended matrix band with a “Bitine” ring clamp and leaf-like matrix bands. The embodiments of the present disclosure are adaptable for use with existing systems of matrix bands, including those utilizing the Tofflemire system and the Bitine ring clamp system. In FIG. 2, dental restoration 200 utilizing existing Bitine sectional matrix band systems on a molar of the lower jaw 210. Teeth 226-231 are in close contact with one another. Tooth 230 is in need of restoration, with a dental carie that has been removed to leave a cavity 240 in need of dental restoration. The restoration of tooth 230 extends to the proximal border of tooth 230, so that following drilling of material during restoration, the contact between tooth 230 and the anterior surface of tooth 131 is removed. Matrix band 244, when properly implemented is preferably in a position where the insertion of a filling fills the space between the cavity 240 and matrix band 244, and following removal of matrix band 144, recreates the close contact between tooth 130 and tooth 131. The Bitine system utilizes a spring-loaded ring 242 with appended jaws 246 and 248 to maintain the position of the sectional matrix band 244 around tooth 230. Following restoration, release of Bitine ring 242 and removal of matrix band 244 leaves an interproximal gap approximating the thickness of matrix band 244.

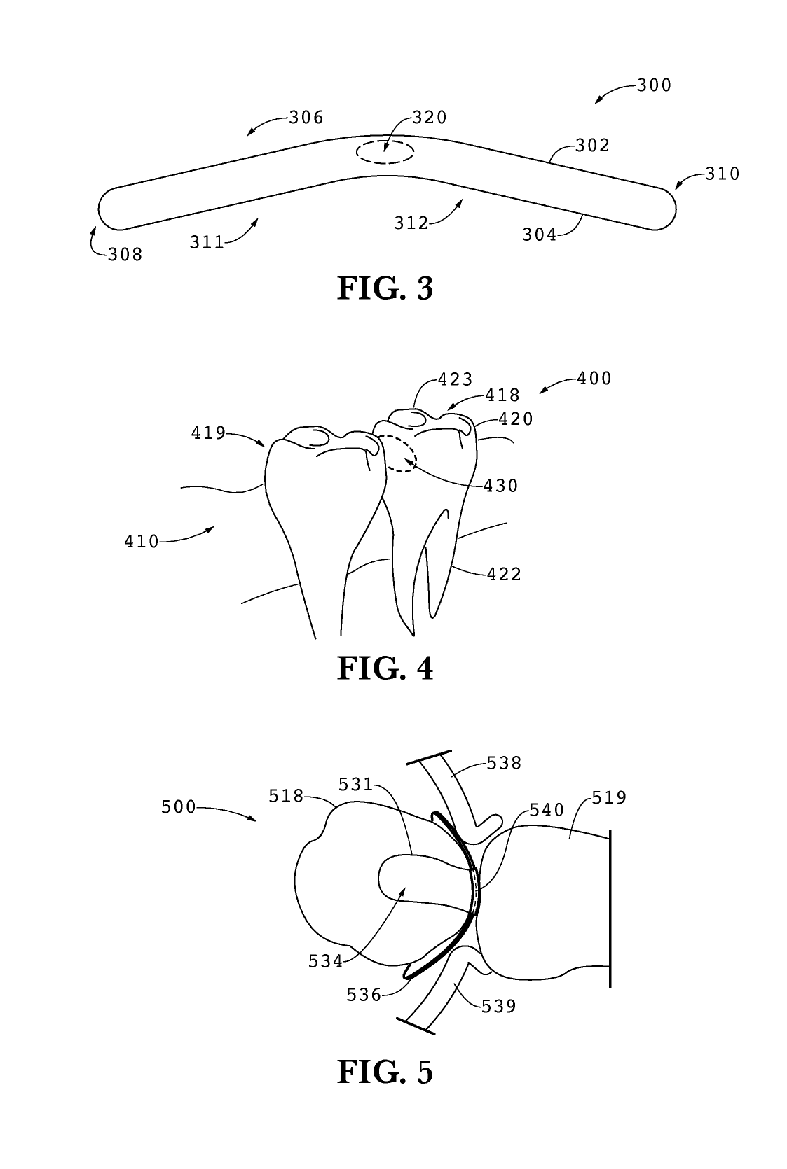

FIG. 3 is a side view of one embodiment of the new contact matrix band. Matrix band 300 is a dental restoration contact matrix band suited for use with a Tofellmire clamp. Contact matrix band 300 is shown with an elongated body portion 306, formed of impervious material with high tensile strength, such as stainless steel. The band portion 306 has a first and second opposing ends (308, 310), and a body with a cross section thin enough to be inserted into the interproximal gap between two teeth. Typically, an angle is formed in the longitude of the body, between a first end 311 and a second end 312. Between the first and second ends is a contract matrix area 320. In a preferred embodiment, the contact matrix is an elliptical area. The contact matrix area can be shaped to conform with a variety of interproximal contacts. Therefore, in alternative embodiments, the contact matrix is a rectangular, square, circular or irregularly shaped area, such as a dumbbell or dog bone shape. As shown in FIG. 3, the width to length ratio of the matrix band body is approximately 1 to 20. Other typical ratios may be 1 to 10 or 1 to 5. As discussed below in relation to FIG. 5, matrix bands for use with the Bitine system will typically have a width to length ratio of 2 to 1, 1 to 1 or less.

Affixed to the contact matrix area 320 is a contact matrix formed of contact matrix material with a contact matrix area approximating the form of the preexisting inter-proximal contact. According to the system of the invention the contact matrix is affixed to the contact matrix area with a bond of moderate strength, sufficient to retain the contact matrix to the contact matrix band during insertion of the matrix band into the interproximal space, but a weak enough attachment that the attachment to the matrix band can be separated at the conclusion of the dental restoration. As described below, a number of mechanisms for retaining the contact matrix to the contact matrix area are available as disclosed herein. Thus, the association between the band portion and the contact matrix allows the contact matrix band to be separated from the contact matrix band during a dental restoration procedure.

When a dental restoration is performed, the contact matrix band is placed in a position occupying the interproximal gap between the tooth being restored and the adjacent tooth. Filling matrix is used to fill a prepared tooth cavity, and is contained by the contact matrix band. The contact matrix material is formed of dentally compatible materials sufficiently compatible the material to be used to fill the cavity, i.e. the expected filling matrix, so that the contact matrix and the filling matrix will form a permanent bond between the contact matrix material and the filling matrix. The filling matrix bonds with the contact matrix so that the association between the band portion and the contact matrix can be broken without displacing the contact matrix. This allows the band portion to be removed, and the contact matrix to remain in the interproximal gap between the two teeth.

In a preferred embodiment the contact matrix is permanently bound to the filling matrix and provides a close contact with the adjacent tooth, while minimizing the inter-proximal gap. The bond between the materials need too be sufficiently permanent to be maintained through the life of the dental restoration. Dental restorations may be temporary, for instance a few weeks during an implant procedure, or for decades in certain restoration in otherwise healthy permanent molars.

FIG. 4 is a perspective view of two teeth with a restoration contemplated in the interproximal gap between the teeth. Dentition portion 400 shows a lower left jaw, 410 carrying two teeth, 418 and 419. Tooth 418 is shown with a crown 420 with embedded roots 422, and several cusps, as at 423, on the occlusal surface. A cavity 430 (dental cane) is present on the interproximal surface of tooth 418. During the restoration procedure, a typical Type II restoration will require removal of the decayed tooth material. In order to completely remove the decayed material and allow for implanting filling matrix, removes the tooth structure up to the occlusal surface of the crown.

FIG. 5 shows a top view of teeth, such as shown in FIG. 4, with a cavity prepared for implantation of filling matrix. Restoration 500 shows teeth 518 and 519, with a prepared cavity 531 in tooth 518 that extends into the interproximal region 534 between teeth 518 and 519. As shown in FIG. 5, a sectional contact matrix band 536 is in place between the teeth, and is held in place by clamp arms 538 and 539. FIG. 5 also shows contact matrix 540 located at the interproximal gap between teeth 518 and 519.

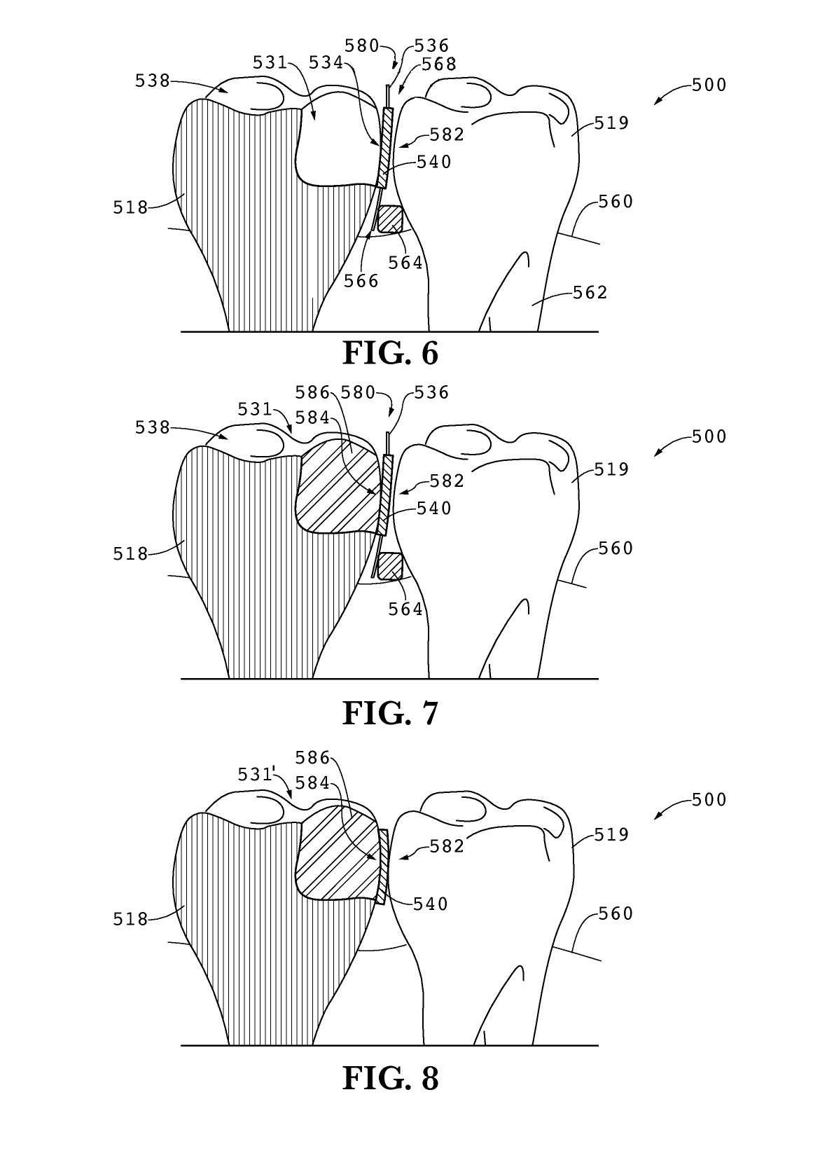

FIGS. 6 through 8 show partial cross sections of a tooth with an interproximal dental carie, such as shown in FIG. 4. The tooth is shown undergoing restoration utilizing the contact matrix bands disclosed herein. Restoration 500 shows teeth 518 and 519, with a prepared cavity 531 in tooth 518 that extends into the interproximal region 534 between teeth 518 and 519. Tooth 518 is shown as a cross section to reveal the internal structure of the region being restored. The gingival margin is shown at 560, with the roots of tooth 519 shown at 562. As shown in FIGS. 6-8, a contact matrix band 536 is in place between the teeth. With respect to contact matrix band 536, the band 536 could be a sectional contact matrix band as shown in FIG. 5, or it could alternatively be a Tofflemire compatible matrix band as shown in FIG. 1. Also in FIGS. 6-8, the contact matrix 540 is located at the interproximal gap between teeth 518 and 519. The contact matrix band 536 has a lingual margin 568 and a gingival margin 566.

Prior to undertaking the restoration shown in FIG. 6, interproximal contact, shown generally at 580, was created by physical contact between contact region 582 of tooth 519 and contact region 584 of tooth 518. Preparation of cavity 531 opened the cavity to the occlusal surface 538 of tooth 518. The cavity preparation also removed tooth structure in the region of the interproximal contact 580. In order to restore the tooth by the placement of filling matrix in the prepared cavity, the tooth margin 534 needs to be recreated in order to recreate the contact region 584 of tooth 518. The contact matrix band is inserted into the interproximal gap, and clamped in place. One or more wedges, as at wedge 564 are forced between teeth 518 and 519 to force the gingival margin of matrix band 536 into close contact with tooth 518 thereby containing the filling matrix within cavity 531. Contact matrix 540 is placed against the cavity margin 534, and is held in place by clamps or wedges. Once the filling matrix is compacted into the prepared cavity 531, the contact matrix 540 will recreate the contact region 584.

As shown in FIG. 7, following the cavity preparation and emplacement of the contact matrix band, restoration proceeds with the placement of filling matrix in the prepared cavity. Due to the presence of contact matrix band 540, the tooth margin 534 is recreated by the bonding of the filling matrix to the contact matrix. Thus, the contact between tooth 519 at region 582 is recreated with the contact region 584 of tooth 518. The contact matrix band is inserted into the interproximal gap, and clamped in place. As shown in FIG. 8, once the filling matrix 586 has cured within the prepared cavity 531, wedge 564 is removed, and contact matrix band 536 is shifted to disrupt the connection between contact matrix 540 and contact matrix band 536. The separation of the contact matrix from the contact matrix band allows the contact matrix band to be removed. As will be further described in the following description, the formation of a bond between the filling matrix and the contact matrix allows for a stronger connection between the filling matrix and the contact matrix than between the contact matrix and the contact matrix band. Thus, the system allows the contact matrix to stay securely in place in the restoration, while the contact matrix band can be readily removed without damaging the restoration or injuring the patient.

The completed restoration, shown in FIG. 8, leaves teeth 518 and 519 with tight interproximal contacts. This contact is further maintained because the teeth were not forcibly displaced during restoration in an attempt to leave space for a contact matrix band while seeking tight interproximal contact. Thus the permanent emplacement of the contact matrix 540 will recreate the contact region 584 of tooth 518, allowing tight contact with contact region 582 of tooth 519. The contact region 584 is finally polished to create a smooth and ledge free interproximal restoration using standard polishing techniques.

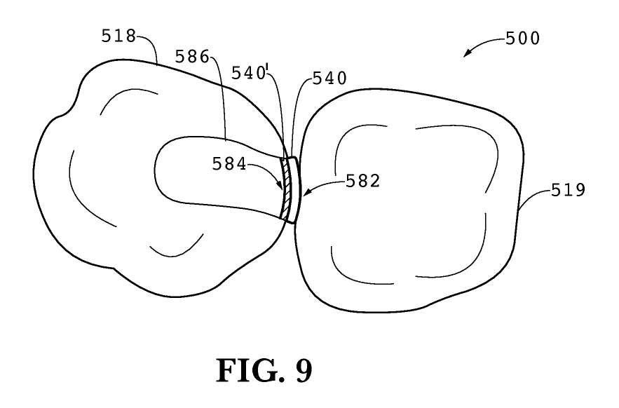

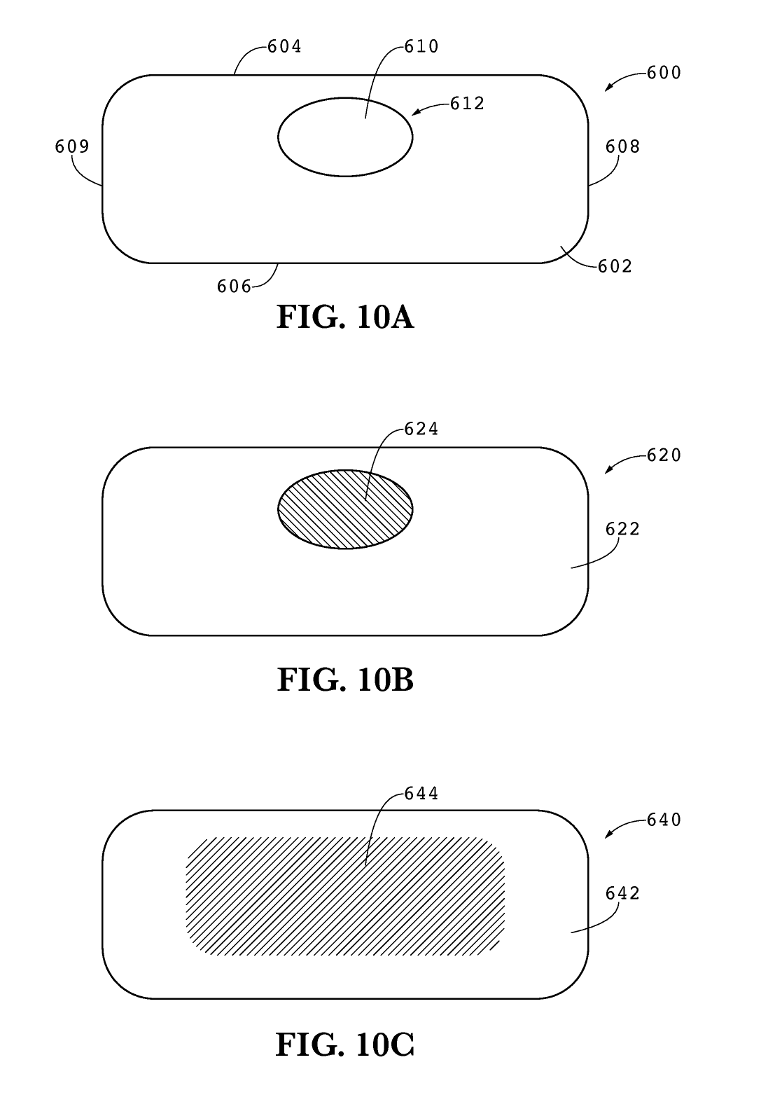

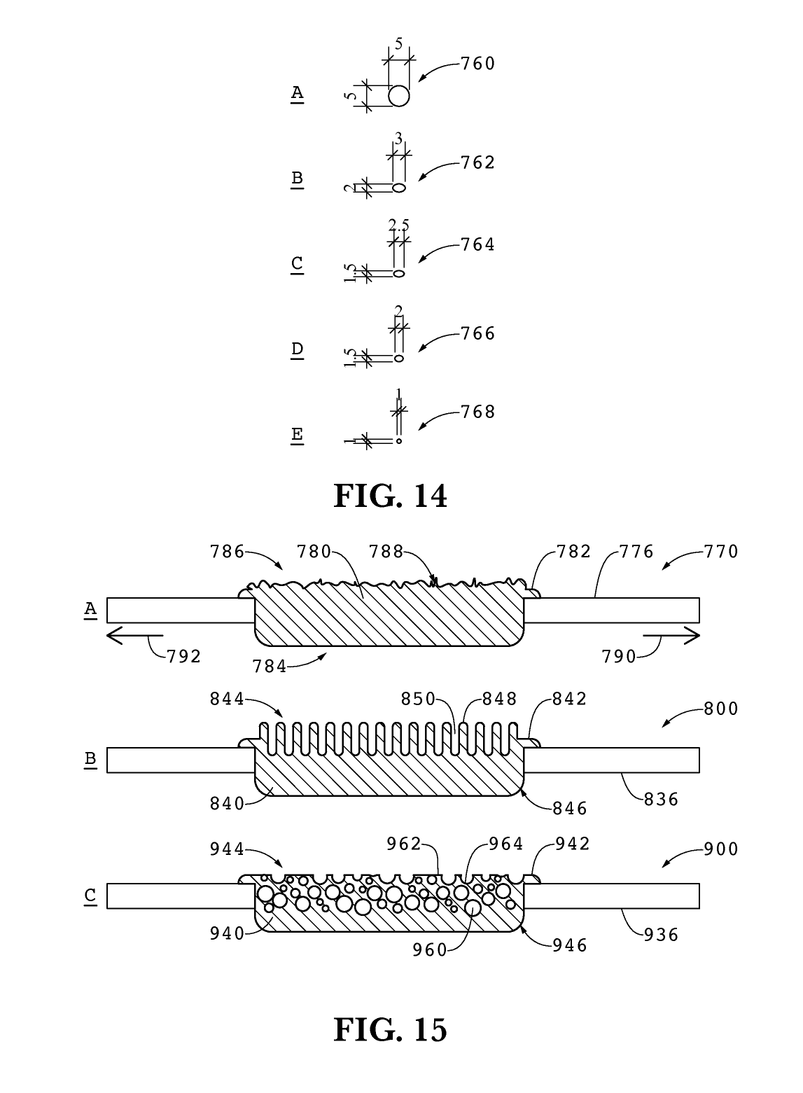

After completion of the restoration, the contact matrix band system provides for the restoration to have the look, feel and structure of the teeth prior to undertaking the restoration. FIG. 9 shows a top view of the completed restoration with a contact matrix 540 emplaced in the interproximal gap, using the embodied system. As shown in FIG. 9 teeth 518 and 519 have maintained, or regained tight interproximal contacts in regions 582 and 584. In an alternative embodiment, as described in connection with FIG. 14 below, along with the other figures, a selection of contact matrix size and shapes can be provided. While the contact matrix 540 shown in FIGS. 8 and 9 occupies the gap, the contact matrix could be sized to fit within the border of the cavity preparation. With a contact matrix occupying space 540′, shown in phantom, the contact matrix band system provides a margin for the restoration, and cavity filling, while leaving no lasting change to the configuration of the tooth contacts.

The contact matrix bands can be made available in a number of configurations. FIG. 10A-C show several front views of alternative embodiments of the contact matrix band. It should be recognized that each of these views shows a relative area for the contact matrix, but the illustrations in FIG. 10 are not exhaustive. Those skilled in the art will recognize other contact matrix forms that may be useful for a particular restoration. In FIG. 10A, dental restoration contact matrix band 600 is comprised of an elongated band portion 602 formed of impervious material with high tensile strength. The band portion has a first and second opposing ends, 608, and 609, and a body with a cross section thin enough to be inserted into the interproximal gap between two teeth. Band 602 has a top margin 604 and a bottom margin 606. As shown in FIG. 10, the top margin and the bottom margin are continuous, without interruption by gaps or intervening contact matrix. Area 610 is shown as an oval hole in band 602, and will provide a location for the contact matrix to reside. Contact matrix area 612 is bordered by edge 612. The size and shape of area 610 are adaptable to the needs of the dental surgeon. In general, the contact matrix formed of contact matrix material compatible with filling matrix material has a contact matrix area approximating the form of the preexisting inter-proximal contact, or with the desired post-restoration inter-proximal contact. It is expected that the contact matrix material will be sufficiently compatible with the chosen filling matrix for a particular restoration to form a permanent bond between the contact matrix material and the filling matrix.

A number of implementations are available to form the desired association between the band portion and the contact matrix to allow the contact matrix band to be separated from the contact matrix during the final stages of a dental restoration procedure. As shown in FIG. 10A, the contact matrix could have a physical position surrounded by the band 602. Alternatively, a stainless steel matrix band could be chemically etched to allow the contact matrix to displaceably bind to the surface of the matrix band. FIG. 10B shows contact matrix band 620, with a chemically etched matrix band 622, where the etched area is represented by contact matrix area 624. Etched area 624 does not completely penetrate band 622, therefore allowing the contact matrix to be removeably attached to the surface of band 622 in area 624. It should be recognized that a contact matrix of a polymerizing liquid could be spotted on the contact matrix area 624, and following completion of polymerization, the etched area 624 would form relatively secure bond with the polymerized contact matrix, or at least a stronger bond than with the un-etched band. As shown in FIG. 10C, rather than chemical milling, abrasion or physical milling could be used on contact matrix band 640, so that band 642 provides a bonding area 644 for the adhesion of contact matrix to all or part of bonding area 644.

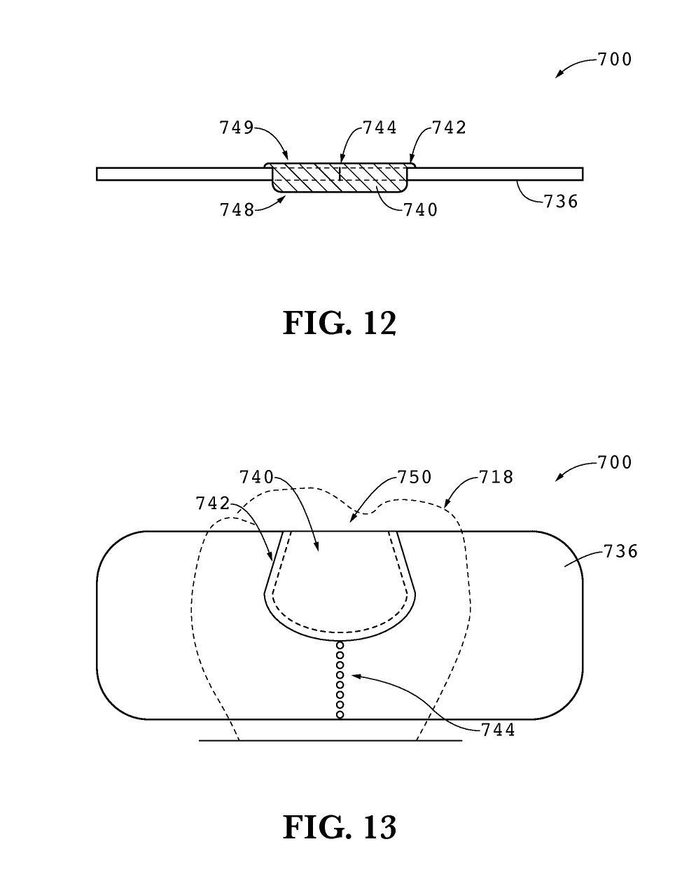

In another alternative embodiment, referring to area 624 of FIG. 10C (shaded) (and similarly area 644 of FIG. 10C) is either milled or chemically etched, to a greater extent than to simply provide a bonding surface, i.e. to thin the original thickness of the matrix band to a greater extent. In this alternative embodiment, the thinning of the cross section of the matrix band is less than as shown in FIG. 12, i.e., without perforating the band. In essence a hollow, or matrix material pocket is formed. By doing so, the availability of the contact matrix material pocket simplifies the manufacturing process of the band and provides for greater surface area or space for the restorative material to fill between the teeth. The end result is variable thickness contact matrix band that produces a filling with a better contact than one provided by a band of a single thickness. As is apparent, in conjunction with the following figures, the various configurations of a contact matrix pocket may be combined with other iterations of the contact matrix band, in particular the addition of a scoring or perforated fracture line.

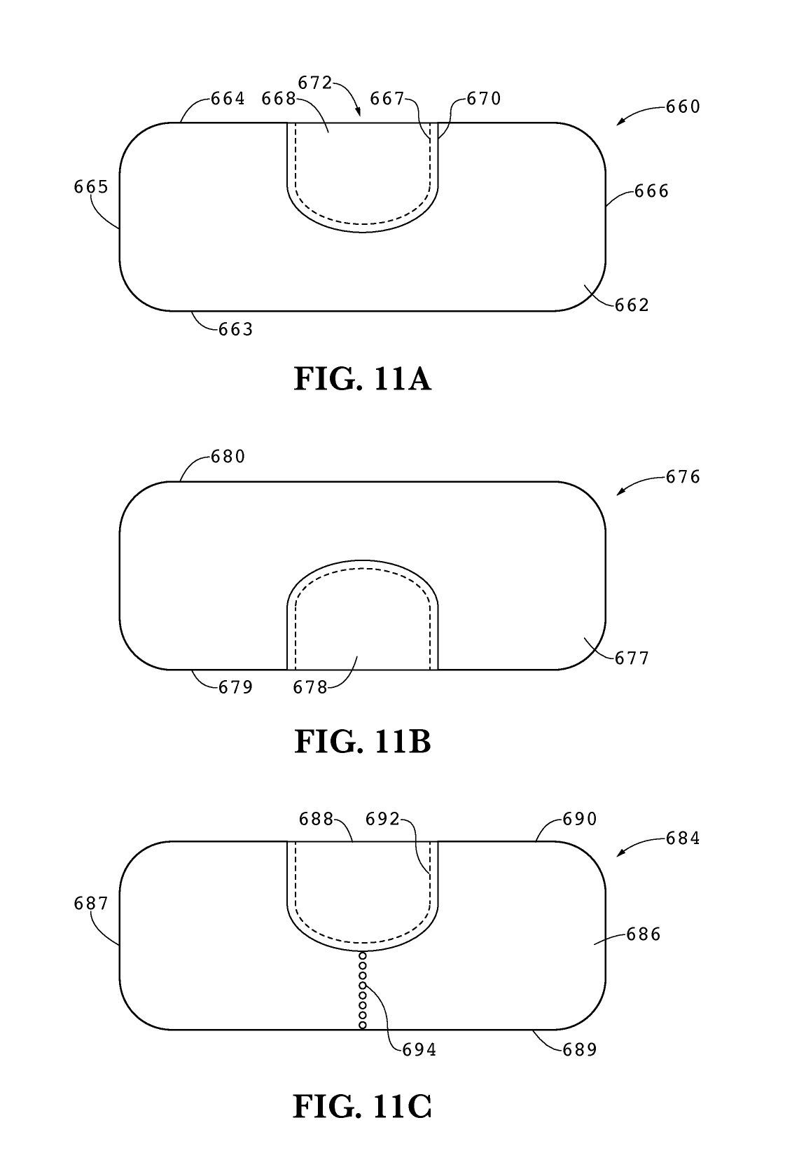

An objective of the contact matrix band system, as embodied particularly in FIGS. 10 and 11 is that when a dental restoration is performed, the contact matrix band is placed in a position occupying the interproximal gap between the teeth, and filling matrix bonds with the contact matrix, but the association between the band portion and the contact matrix can be broken without displacing the contact matrix. Thus, this allows the band portion to be removed, and allows the contact matrix to remain in the interproximal gap between the teeth. Turning to FIG. 11, panels 11A-C are front views of embodiments of the contact matrix band with a contact matrix channel. As shown in FIG. 11, the contact matrix area as a channel differs from the contact matrix areas in FIG. 10, so that the contact area edge is not fully surrounded by contact matrix band, but is contiguous in part with the band margin. FIG. 11A shows a contact matrix band 660, with a band body 662, bottom edge 663, top edge 664, and ends 665 and 666. The contact matrix area 668 is shown as a channel cut through matrix band 662. Thus contact matrix edge 667 extends to top margin 664, so that upper contact matrix margin 672 forms part of the top margin 664. Also shown in FIG. 11A is an alternative embodiment, comprising the contact matrix extending beyond the contact matrix area edge 667 to retaining lip 670, so that the contact matrix is retained more securely on the matrix band 662. Similar overlap of the contact matrix could be provided in combination with the embodiments shown in FIG. 10-15. Refer also to the top view of the system shown in FIG. 12. FIG. 11B shows a nearly identical contact matrix band system 676, but the alternative embodiment is that the contact matrix area 678 is contiguous with bottom edge 679, rather than top edge 680. It should be recognized that although the matrix band 677 is shown as a simple rectangular strap, the matrix band could alternatively be any of the various sectional matrix bands, or a matrix band with asymmetry between the top and bottom edge conformations. Those skilled in the art of dental surgery will recognize the need for a variety of matrix band shapes.

FIG. 11C shows another alternative embodiment of a matrix band with a channel contact matrix area. The contact matrix band 684, with a band body 686, end margins 686 and 687 and bottom margin 689. The contact matrix area 688 is shown as a channel cut into top margin 690, top edge 664, and through matrix band 686. The contact matrix extends beyond the contact matrix area edge 692 to secure the contact matrix on the matrix band 662. An additional embodiment is a stress fracture region 694. Lateral or torsion stress about the ends of the contact matrix band will cause the matrix band 686 to fracture or tear along fracture region 694, allowing the two ends 686 and 687 to be readily extracted from the interproximal region following restoration without displacing the filling or the contact matrix. As shown in FIG. 11C, the stress fracture region 694 could be perforations through the matrix band 686, indentations, a score line, or other weak zone along the matrix band. Thus, a fracture line allows the contact matrix band to fracture or tear at a predictable location. FIG. 12 shows a top view of the contact matrix band 700 similar to the embodiment shown in FIG. 11C. Matrix band 736, has a channel occupied by contact matrix 740, with the contact matrix having a proximal face 748 and a distal face 749. Distal face 749 of the contact matrix is shown extending over the contact matrix edge 742, while the proximal face of contact matrix 740 protrudes from the face of contact matrix band 736. Stress fracture region 744 is positioned along about the centerline of the contact matrix. Alternatively, the edge zone could be etched to foster better adhesion, the contact matrix could protrude from both, or neither face, and the edge could overlap the matrix band on either face.

FIG. 13 is a side view of a contact matrix band 700 as shown in FIG. 12 with the contact matrix band shown as it would be placed on a molar. Contact matrix band 736 is shown in front of molar 718. Contact matrix 740 has an edge overlap 742. Stress fracture region 744 is approximately equidistant from the two sides of the molar. Fracture of region 744, frees contact region 744 from matrix band 736, and the ends of the matrix band can be withdrawn from between two adjacent molars or other teeth. Top edge 750 of contact matrix 740 is narrower than the maximum width of the contact matrix region. This conformation serves to better retain the contact matrix upon the matrix band, and alternatively could be adapted to the shape of the dental restoration or interproximal contact.

FIG. 14 displays several views of various contact matrices, demonstrating that the actual size and shape can be varied to fit particular applications and needs. The contact matrices shown in FIG. 14 would be removeably attached to a matrix band utilizing the Tofflemire, sectional matrix, or other system. FIG. 14A shows a circular form contact matrix 760 about 5 mm in diameter. FIG. 14B shows an ovoid form contact matrix 762 about 2 mm by 3 mm, while. FIGS. 14C and 14D show ovoid forms of contact matrix 764 and 766 about 1.5 mm by 2.5 mm and 1.5 mm×2 mm respectively. FIG. 14E shows a circular form contact matrix 768 about 1 mm diameter. Although not shown in detail in FIG. 14, the contact matrix will typically be used in an oblate, or flattened three-dimensional conformation. Thus, a variety of overall circular or ovoid cross sections from one axis may be utilized, with the thickness and relative height to width ratio being similarly varied along the opposing axis. In a particularly preferred embodiment, a contact matrix with an ovoid contact face, is combined with a flattened cross section.

It is well known that a variety of shapes of contact faces may be desired, and the thickness of the interproximal gap is also variable. A kit of the most favored sizes of contact matrices may be provided. In yet another alternative embodiment, the contact matrix band as shown in FIG. 12 or 13, may be provided with a contact matrix foot, that snaps into place on a contact matrix band as shown in FIGS. 12 and 13. A contact matrix foot could be further provided with a contiguous contact matrix body of variable shape, so that a variety of contact matrices could be mated with a limited number of contact matrix bands, as conditions arise.

The maintenance of the bond between filling matrix and contact matrix has been a difficult matter requiring experimentation. As previously described, in order to utilize the system most effectively the contact matrix must be more securely attached to the cured filling matrix than it is to the contact matrix band. The goal is for enhanced bond to filling matrix material for long term retention of the contact matrix to the restoration, and a detachable attachment of the contact matrix to the contact matrix band. The contact matrix-band retention may be a physical adhesion, using cement, glue or other enhancements discussed herein. It also could rely on structural retentions methods such as an overlapping contact matrix edge, or a contact matrix region shape that helps retain the contact matrix (See FIG. 13). FIG. 15A-C are sectional views of contact matrix bands where the contact matrices are embodied for enhanced bonding to filling matrix. In FIG. 15A, a protruding surface of a contact matrix is abraded to provide more bite to a bond between the contact matrix and filling matrix. Contact matrix band 770 is comprised of band portion 776 and contact matrix 780, with overlapping lip 782. Distal face 784 is opposed by proximal face 786. Proximal face 786 has been abraded by common means to provide a rough surface with a number of irregularly shaped protrusions, such as 788. Contacting filling matrix with proximal contact matrix surface 786 provides better adhesion, and a stronger filling matrix-contact matrix bond than the unabraded surface. Removal of the matrix band typically would involve lateral forces perpendicular to the tooth. Thus forces in the directions of force 790 and 792 are restrained by the invaginations in the contact matrix. These lateral forces are typically the forces that must be resisted to separate the contact matrix from the contact matrix band.

FIG. 15B shows a similar method of increasing filling matrix bond to the contact matrix. Contact matrix band 800 is comprised of band portion 836 and contact matrix 840, with overlapping lip 842. Distal face 846 is opposed by proximal face 844. The proximal face 844 has been formed to have channels or fingers, forming lands 848 and grooves 850. These structures could be formed by molding, milling or similar means that are generally available. When filling matrix is forced into close contact with proximal contact matrix surface 844, it fills the grooves, and so long as the filling matrix has sufficient strength, the contact matrix is difficult to laterally displace along the filling matrix.

Finally FIG. 15C shows a contact matrix created with a irregular surface configured to reduce the possibility that the contact matrix is separated from the cured filling matrix. Contact matrix band 900 is comprised of band portion 936 and contact matrix 940, with overlapping lip 942. Distal face 946 is opposed by proximal face 944. During the process of forming the contact matrix, a number of bubbles 960 in the material of the contact matrix are formed. When the proximal surface is ground or milled away, variously shaped cavities are revealed. Proximal face 944 reveals a number of irregularly shaped surfaces 962 and cavities 964. When filling matrix is extruded into close contact with proximal contact matrix surface 944 the cured filling matrix is tightly bound to the contact matrix.

The system is further embodied in a kit comprising the components necessary to utilize the system in day-to-day dental practice. Such a kit would comprise a system utilizable with the typical Tofflemire clamp, while a separate kit would be generally utilizable with the Bitine sectional band system. The kit would contain a series of contact matrix bands of variable sizes; a selection of several sizes of contact matrix proportional to the interproximal contact area affixed to the contact matrix band, a selection of several shapes of interproximal gaps, in combination with the various contact matrix areas; and one or more clamps compatible with the contact matrix bands supplied. Thus, one kit would be expected to have elongated contact matrix bands, and a separate kit would be expected to provide a variety of contact matrix bands in a sectional matrix band conformation.

As described, the system allows for maintaining or recreating close interproximal contacts between teeth following restoration. The system provides an improved system for use in dental surgery, and in the end produces a previously difficult-to-obtain result for dental patients.

While the assembly and components thereof has been described with reference to various embodiments, those skilled in the art will understand that various changes may be made and equivalents may be substituted for elements thereof without departing from the scope and essence of the disclosure. Additionally, many modifications may be made to adapt a particular situation or material to the teachings of the disclosure without departing from the essential scope thereof. Therefore, it is intended that the disclosure may not be limited to the particular embodiments disclosed, but that the disclosure will include all embodiments falling within the scope of the appended claims. In this application the US measurement system is used, unless otherwise expressly indicated. Also, all citations referred to herein are expressly incorporated herein by reference.

I claim:

1. A method for repairing an inter-proximal cavity during restoration of a tooth comprising:
(a) inserting a contact matrix band in the interproximal gap adjacent to the inter-proximal cavity, said contact matrix band having a contact matrix approximating the form of the preexisting inter-proximal contact, said contact matrix compatible with the filling matrix and removeable from the contact matrix band;
(b) clamping the contact matrix band to close apposition with the borders of the inter-proximal cavity and desired inter-proximal contact;
(c) placing filling matrix in the cavity of the tooth in close contact with the walls of the cavity and the mesial surface of the contact matrix;
(d) allowing the filling matrix to cure and to bond with the contact matrix; and
(e) displacing the contact matrix band from the inter-proximal gap without displacing the contact matrix,
wherein the contact matrix is permanently bound to the filling matrix and provides a close contact with the adjacent tooth, while minimizing the inter-proximal gap.

2. The method of claim 1 wherein said matrix band is compatible with one or more of a Tofflemire clamp, or a ring clamp.

3. The method of claim 1 wherein the contact matrix band is compatible with a Tofflemire clamp and said contact matrix band encircles the tooth with the cavity in need of restoration.

4. The method of claim 1 further comprising a contact matrix band with a channel, a perforation strip, or a perforation strip and a channel.

5. The method of claim 1 further comprising a collection of matrix bands with 3 or more shapes of contact matrices.

6. A dental restoration contact matrix band comprising:
a) an elongated band portion formed of impervious material with high tensile strength, said band portion having a first and a second opposing ends, and a body with a cross section thin enough to be inserted into the interproximal gap between two teeth;
b) a contact matrix formed of contact matrix material with a contact matrix area approximating the form of the preexisting inter-proximal contact;
c) said contact matrix material being sufficiently compatible with an expected filling matrix to form a permanent bond between the contact matrix material and the filling matrix;
d) an association between the band portion and the contact matrix that allows the contact matrix band to be separated from the contact matrix band during a dental restoration procedure;
whereby when a dental restoration is performed, the contact matrix band is placed in a position occupying the interproximal gap between the teeth, and filling matrix is used to fill a cavity said filling matrix bonds with a proximal surface of the contact matrix so that the association between the band portion and the contact matrix can be broken, without displacing the contact matrix, allowing the band portion to be removed, and allowing the contact matrix to remain in the interproximal gap between the teeth, so that the contact matrix is permanently bound to the filling matrix and provides a close contact with the adjacent tooth, while minimizing the inter-proximal gap.

7. The contact matrix of claim 6 further comprising a contact matrix band compatible with one or more of a Tofflemire clamp, or a ring clamp.

8. The method of claim 6 wherein the contact matrix band is compatible with a Tofflemire clamp and said contact matrix band body is sufficiently elongated to encircle the tooth with the cavity in need of restoration and attach to the Tofflemire clamp.

9. The contact matrix band of claim 6 further comprising a contact matrix band with a channel, a perforation strip, or a perforation strip and a channel.

10. The contact matrix band of claim 6 further comprising a collection of contact matrix bands with 3 or more shapes of contact matrices.

11. The contact matrix band of claim 6 further comprising a contact matrix that is a rectangular, square, circular, dumbbell, dog bone, or irregularly shaped area.

12. The contact matrix band of claim 6 further comprising a contact matrix wherein the width to length ratio of the matrix band body is one or more of approximately 1 to 20, approximately 1 to 10, approximately 1 to 5, approximately 2 to 1, or approximately 1 to 1.

13. The contact matrix band of claim 6 further comprising the proximal surface of the contact matrix has been abraded, roughened with a number of irregularly shaped protrusions, formed to have channels, or formed to have irregularly shaped surfaces and cavities wherein the proximal face exhibits enhanced bonding to a filling matrix.

14. The contact matrix band of claim 13 wherein the proximal surface of the contact matrix is formed to have irregularly shaped surfaces and cavities.

15. A kit providing components necessary for implementing a contact matrix band system comprising a series of contact matrix bands of variable sizes; a selection of several sizes of contact matrix affixed to the contact matrix band said contact matrix being proportional to an interproximal contact area; a selection of several shapes of contact matrices for filling interproximal gaps;

16. The kit of claim 15 further comprising a contact matrix band system utilizable with a Tofflemire clamp, a Bitine sectional band system, or a sectional matrix band system.

17. The kit of claim 15 further comprising a set of contact matrix bands providing a combination of contact matrix areas and shapes for filling interproximal gaps

18. The kit of claim 15 further comprising contact matrix bands with one or more of a channel, a perforation strip, or a perforation strip and a channel.

19. The kit of claim 17 further comprising a selection of contact matrix bands with 3 or more shapes of contact matrices.

20. The kit of claim 19 further comprising a contact matrix band with a proximal surface of the contact matrix which has been abraded, roughened with a number of irregularly shaped protrusions, formed to have channels, or formed to have irregularly shaped surfaces and cavities wherein the proximal face exhibits enhanced bonding to a filling matrix.
